(19) United States
(12) Patent Application Publication
(10) Pub. No.: US 2017/0359298 A1
(43) Pub. Date: Dec. 14, 2017

(54) SYSTEM AND METHOD FOR RECEIVING AND DELIVERING TEXT MESSAGES FROM MULTIPLE SOURCES

(71) Applicants: Robert Ezzat Semaan, Aventura, FL (US); Andrew Robert Semaan, Miami, FL (US)

(72) Inventors: Robert Ezzat Semaan, Aventura, FL (US); Andrew Robert Semaan, Miami, FL (US)

(21) Appl. No.: 15/182,076

(22) Filed: Jun. 14, 2016

(51) Int. Cl. H04L 12/58; H04M 1/725

(52) U.S. Cl. CPC H04L 51/36; H04L 51/046; H04M 1/72552; H04L 51/32

(57) ABSTRACT

The present invention is a method and system designed to take multiple apps, each having their own text messaging services, and combine them into one place for a user to send and receive text messages.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to text messaging reception and delivery systems and methods. Specifically, the invention relates to a system and method for receiving and delivering text messages from multiple sources to a single application on a single device.

### Description of Related Art

The use of text messaging on various applications (apps) on internet connected communication devices, such as cell phones, smartphones, PCS phone, personal digital assistants, and computers in general, has become very prevalent. Systems, such as WhatsApp™, Viber™, a Short Message Service (SMS), Skype™, Facebook™, LinkedIn™, and others, provide a means for exchanging real time text messages between members on the particular service. While email remains very popular, text messaging is popular once a contact with a person is made, and now text messaging is even being used to make initial contact to known and unknown individuals. Even voicemail does not rival the number of text messages utilized on different applications.

While voicemail and email tend to be delivered to a single location, such as your phone, your business, or your home email address regardless of what application is being utilized, each text messaging system application has an independent texting system which requires launching the application to receive and send text messages. Also, it is common to miss a message from one system or the other, since the different apps could be on the different pages or location on the smartphone, especially when most people are communicating over at least 5 or 6 systems. This creates a time issue, as well as problems in knowing where a particular recipient is located i.e. which application do I use to contact a particular individual. Accordingly, the current text messaging system has been, and still is, fragmented and has multiple issues preventing further growth.

### BRIEF SUMMARY OF THE INVENTION

The present invention relates to the discovery of a system and method to overcome the problems existing in the current technology. More specifically by having an app that collects text messages from all sources available in one place on a computer (such as a smartphone) that supports text messaging, and presenting the messages in one place, the disadvantages and problems are mitigated or overcome. The system can be an application in combination with software on a server or entirely integrated into a computer application.

Accordingly, in one embodiment, there is a compiling system for organizing a user's plurality of sent and received text messages on a computer, the messages which are sent to and received from a plurality of different text messaging systems, the compiling system comprising:
a) a compiling app on the user computer which takes text messaging received on the user computer from the different text messaging systems and compiles them for the user to view on the user computer;
b) the compiling app having a text message system which allows the user to send a text message using any one of the different text messaging systems; and
c) the compiling app having a graphical user interface for viewing and sending text messages from the plurality of different text messaging systems.

Accordingly, in another embodiment, there is a system for organizing a user's sent and received text messages, the messages which are sent to and received from a plurality of different user apps, each user app having their own different text messaging system comprising:
a) a text message supporting user computer connected to the internet having a text message compiling app;
b) a server connected to the internet designed to receive and send text messages to the text message compiling app on the user computer and to each of the different text messaging systems of the user apps; and
c) a computer program associated with the server which;
   i. receives copies of the text messages sent from the user by the compiling app to a designated member of the plurality of different user apps and delivers the text message to the designated member text messaging system via the server; and
   ii. receives text messages from members of the plurality of different user apps text messaging systems and delivers the text messages to the compiling app via the server; and
d) wherein the compiling app compiles the sent and received text messages to and from the plurality of different user apps received from and sent to the server for display on the user computer on the compiling app.

In yet another embodiment, there is a method for organizing a user's sent and received text messages having a text message supporting user computer connected to the internet, the computer having a plurality of different user apps, each user app having their own different text messaging system, the method comprising:
a) providing a compiling app on the user computer;
b) a server on the internet receiving text messages from the compiling app and a program associated with the server deciding which user app text message system to send the text message to;
c) sending the text message to the decided upon text messaging system;
d) the program associated with the server receiving text messages from a plurality of user app text messaging systems;
e) the server sending the text messages to the compiling app on the user computer; and
f) the compiling app compiling the sent and received text messages for the user to view on the user computer.

### BRIEF DESCRIPTION OF THE DRAWINGS

FIG. 1 is a chart of the system of the present invention using a server.

FIG. 2 is a method of the present invention.

FIG. 3 shows the relationship of text messages using the system.

FIG. 4 shows the system contained in a phone application without use of a server or external software.

### DETAILED DESCRIPTION OF THE INVENTION

While this invention is susceptible to embodiment in many different forms, there is shown in the drawings, and will herein be described in detail, specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

### DEFINITIONS

The terms “about” and “essentially” mean ±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

References throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein, the term “text messages” refers to electronic messages sent from one device to one or ore other devices. In one embodiment, the messages are sent from a mobile device to one or more other mobile devices. Text messages refers to both SMS and MMS messaging, and includes image, video, and sound content, as well as text content. In the present invention, it is acknowledged that different service providers provide a different text message system, e.g. Facebook™, iPhone™, Android™, LinkedIn™, WhatsApp™, Viber™, and the like, all have different systems for delivering text messages between users of their system. In the present system, in one embodiment, at least one copy of all text messages of a user go through a common server or a compiling app in the computer (smartphone) which collects the text messages and delivers them to one place on the user's phone (e.g. graphic user interface or GUI) and allows the user to go to one place on their computer to send and receive text messages to/from different text messaging systems.

As used herein, the term “user” refers to a computer user (smartphone, tablet, desktop, or the like) that has multiple programs, capabilities, or apps (application programs) each of which has their own text messaging system. For example a user might be someone with both Facebook™ and LinkedIn™ on their phone, needing to open two programs to view all their text messaging.

As used herein, the term “different user apps” refers to the user having a plurality of apps on their computer that has internet connectivity, which each app has access to a text messaging system such that the user must open or use each different text messaging system to send a text message, as described above. Once a user has two or more such text messaging systems, the problem exists that multiple systems must be utilized in order to send/receive text messages to everyone on the plurality of text messaging systems.

As used herein, the term “different text messaging systems” refers to the fact that text messaging systems on each of the different apps or computer systems are only useful for sending and receiving text messages to those other users on the particular utility, e.g. Facebook™. A user signs on an app or online and can only use the Facebook™ system to send/receive text messages to those also on Facebook™. Text messages from the different systems can send them to the system of the present invention, or to both their regular text messaging site and the system. Several methods could be utilized. And texts to multiple sites are well-known, though that is not necessary for the practice of the present invention.

As used herein, the term “text messaging supporting user computer” refers to the computer above that has access to a plurality of text messaging systems. For non-limiting purposes of explanation only, a “computer”, as referred to herein, refers to a general purpose computing device that includes a processor. “Processor”, as used herein, refers generally to a device including a Central Processing Unit (“CPU”), such as a microprocessor. A CPU generally includes an arithmetic logic unit (“ALU”), which performs arithmetic and logical operations, and a control unit, which extracts instructions (e.g., code) from memory and decodes and executes them, calling on the ALU when necessary. Included in one embodiment are smartphones. “Memory” as used herein, refers to one or more devices capable of storing data, such as in the form of chips. Memory may take the form of one or more of random-access memory (“RAM”) read-only memory (“ROM”), programmable read-only memory (“PROM”) erasable programmable read-only memory (“EPROM”), or electrically erasable programmable read-only memory (“EEPROM”) chips. Memory may be internal or external to an integrated unit including the processor. Memory may be internal or external (e.g. a server) to the computer. Such memory may store a computer program, e.g., code or a sequence of instructions being operable by the processor. Such a computer may include one or more data inputs. Such a computer may include one or more data outputs. The code stored in memory may cause the processor, when executed by the processor, to set an output to a value responsive to a sensed input.

One type of computer executable code typically stored in memory, so as to be executable by an Internet enabled computer, is a browser application. For non-limiting purposes of explanation only, “browser” as used herein generally refers to computer executable code used to locate and display web pages. Some commercially available browsers are Microsoft Internet Explorer™, Netscape Navigator™, Apple Safari™ and Firefox™, all of which support text, graphics and multimedia information, including sound and video (sometimes through browser plug-in applications).

As used herein, the term “internet” refers to its normal usage to be the system, including the World Wide Web, by which content providers, such as text messaging providers, can supply web content, such as from a server, to be displayed, or published, on internet connected client (or reader) computers operable to access and display the content via a web browser. Therefore, computers, networks, internet connections, operating systems, programs, data structures, processing units, system memory components, system busses, wireless connections, cookies, and other computing hardware and software as known in the art for internet communication can be utilized in the present invention. Thus, without being bound by theory, or limited by lack of precise jargon, the description of the invention below is intended to be understood as being operable in the context of known means for operating websites, payment systems, computers, servers, and user-generated content, all as currently used for internet activity, but lacking in the inventive features of the present invention.

As used herein, the term “text messaging compiling app” refers to a computer program on the user computer, or associated with the server, or an app on a smartphone, or all, which collects text messages from all the user's apps and delivers them to a single program on the user's computer such that all text messages are on the same app, and thus the same computer screen. Likewise, the compiling app takes text messages sent by the user and delivers them to the appropriate app having a text messaging system.

As used herein the term “server” refers to a computing device communicatively coupled to a network and that manages network resources. A server may refer to a discrete computing device, or may refer to an application that is managing resources rather than the entire computing device. An edge proxy server may be a proxy server which is designed to run at the edge of the network, e.g., separating a local network from the Internet. In one embodiment there is no server.

As used herein the term “designated member” refers to one of the apps where a text message is being sent or received. So, in one example where a message is received from Facebook™, Facebook™ is the designated member to receive the text message response.

As used herein, the term “display on the user computer” refers to the computer screen or GUI that a user views the text messages on.

### Drawings

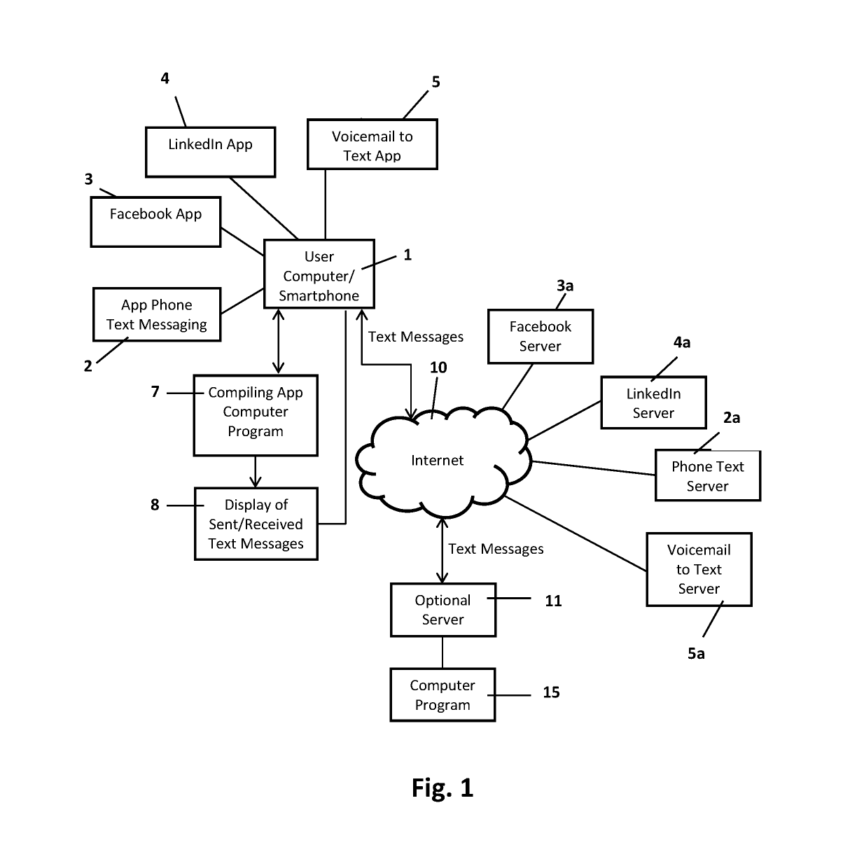

Now referring to the drawings, FIG. 1 is a relationship chart of the system of the present invention using a server. In this embodiment, a user with a computer, such as a smartphone 1, has four different phone apps which send and/or receive text messages. The apps in this example are phone app 2, Facebook™ app 3, LinkedIn™ app 4 and voicemail to text app 5. Each of these apps can receive text messages and all but the voicemail to text app can send text messages. The user 1 has installed the compiling app computer program 7 of the present invention which displays 8 sent and received text messages from the text messaging apps all to the single app and displays all of the messages on a single place/screen, thus avoiding opening each of the apps to send or receive a text message.

The text messages are sent and received using the internet 10, however, while the messages can still go to the individual apps, at least a copy goes to the compiling app for consolidation purposes. As noted, the companies which produce the apps also have internet connections and servers for sending/receiving text messages e.g. phone server 2a, Facebook™ server 3a, LinkedIn™ server 4a and voicemail to text server 5a. As shown, the system has an optional server 11 also internet connected and the server coordinates the send/receive function for the compiling app via computer program 15. Accordingly, it's possible to send/receive from each of the apps regardless if the app is on the computer or not. Merely having access to the app (which could also be just access to a website that is cloud based type app) is sufficient to practice the present invention.

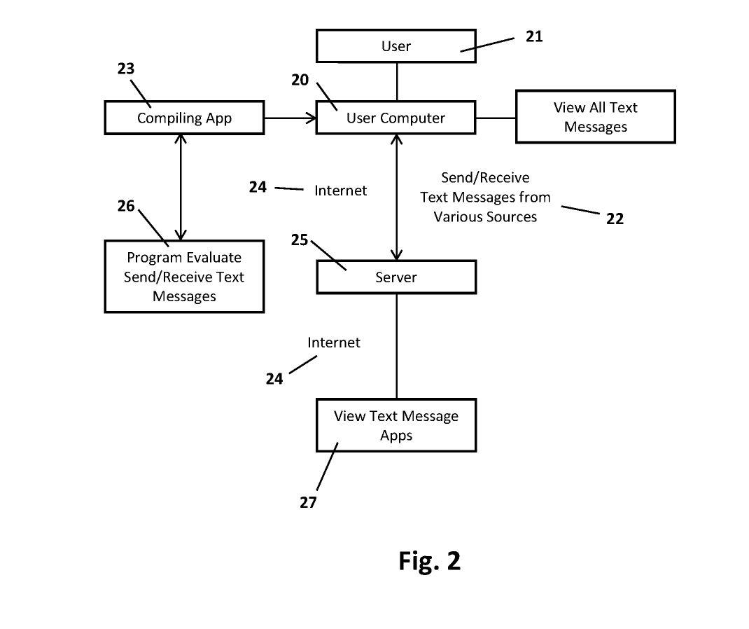

FIG. 2 is a flow/relationship chart of a method of the invention. A user computer 20 has a user 21 which writes a text message 22 utilizing the compiling app 23 which sends the text message 22 over the internet 24 to a server 25 under control of a program 26 which allocates which apps the text messages are sent to and which apps to retrieve 27 for the user.

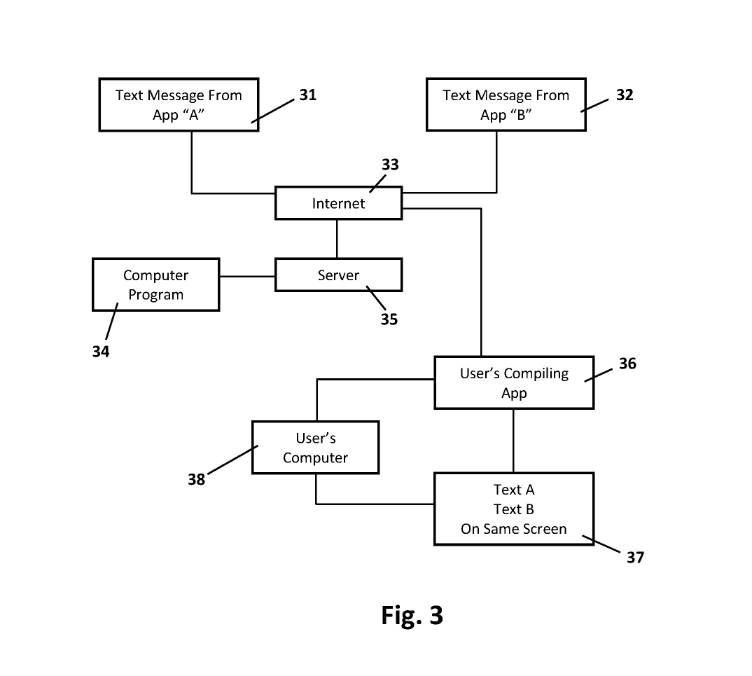

In FIG. 3 there is depicted an embodiment of a typical use of the present invention. In this example, it shows the receipt of two text messages, one from each of two different text message providing services. One can easily see from this example the reverse can be accomplished and any number of text messaging services utilized. A first text message from A 31 and another text message from B 32 are both sent to the internet 33. Server 35 of the present invention recites both text messages 31 and 32 and, utilizing computer program 34 associated with the server, decides which of the user's compiling apps these belong to and resends them over internet 33 to a compiling app 36 on a user's computer 38 where it appears as two messages 31, and 32 on the same screen 37 of the user's computer.

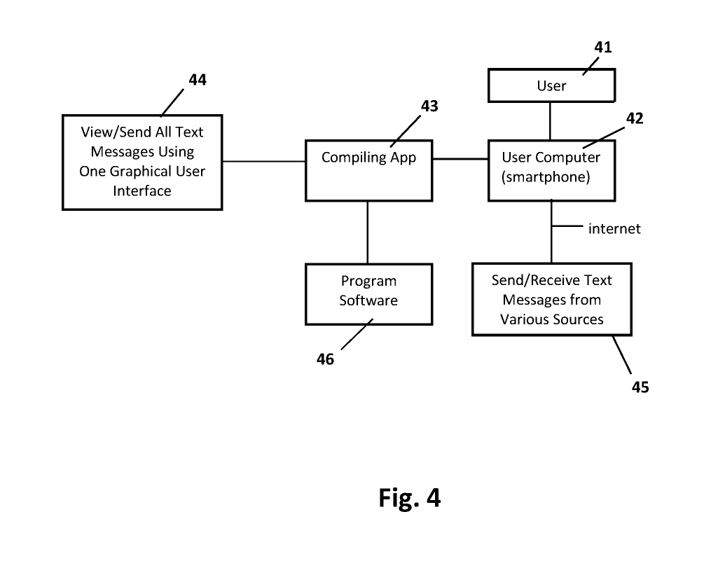

FIG. 4 is an embodiment of the present invention wherein there is no server and the all of the compiling application software is on the user's computer (smartphone). In this view, a user 41 has a user computer 42 such as a smartphone. The user computer 42 has a compiling app 43 with program software 46 for compiling text messages from various sources 45 for the purpose of sending and receiving the text messages from one graphic user interface 44 on the user computer 42.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

What is claimed is:

1. A compiling system for organizing a user's plurality of sent and received text messages on a computer, the messages which are sent to and received from a plurality of different text messaging systems, the compiling system comprising:
a) a compiling app on the user computer which takes text messaging received on the user computer from the different text messaging systems and compiles them for the user to view on the user computer;
b) the compiling app having a text message system which allows the user to send a text message using any one of the different text messaging systems; and
c) the compiling app having a graphical user interface for viewing and sending text messages from the plurality of different text messaging systems.

2. The system according to claim 1 wherein a text message displayed on the graphical user interface uses the symbol of the text messaging system being utilized.

3. A system for organizing a user's sent and received text messages, the messages which are sent to and received from a plurality of different user apps, each user app having their own different text messaging system comprising:
a) a text message supporting user computer connected to the internet having a text message compiling app;
b) a server connected to the internet designed to receive and send text messages to the text message compiling app on the user computer and to each of the different text messaging systems of the user apps; and
c) a computer program associated with the server which;
i. receives copies of the text messages sent from the user by the compiling app to a designated member of the plurality of different user apps and delivers the text message to the designated member text messaging system via the server; and
ii. receives text messages from members of the plurality of different user apps text messaging systems and delivers the text messages to the compiling app via the server; and
d) wherein the compiling app compiles the sent and received text messages to and from the plurality of different user apps received from and sent to the server for display on the user computer on the compiling app.

4. A method for organizing a user's sent and received text messages having a text message supporting user computer connected to the internet, the computer having a plurality of different user apps, each user app having their own different text messaging system, the method comprising:
a) providing a compiling app on the user computer;
b) a server on the internet receiving text messages from the compiling app and a program associated with the server deciding which user app text message system to send the text message to;
c) sending the text message to the decided upon text messaging system;
d) the program associated with the server receiving text messages from a plurality of user app text messaging systems;
e) the server sending the text messages to the compiling app on the user computer; and
f) the compiling app compiling the sent and received text messages for the user to view on the user computer.
